(19) United States
(12) Patent Application Publication
(10) Pub. No.: US 2012/0090580 A1
(43) Pub. Date: Apr. 19, 2012

(54) Controlled-compression direct-power-cycle engine

(76) Inventor: Lung Tan Hu, Langley (CA)

(21) Appl. No.: 12/925,129

(22) Filed: Oct. 15, 2010

(51) Int. Cl. F02B 33/00

(52) U.S. Cl. 123/564

(57) ABSTRACT

The present invention provides a controlled-compression direct-power-cycle engine for performing the direct-power-cycle, wherein the air is compressed with three compression processes and cooled to a controlled temperature before ignition, the engine power output is controlled by both the compressor-transmission and the servo-intake-valve; the three compression processes are the initial-compression-process, the intermediate-compression-process, the final-compression-process, wherein, the initial-compression-process is performed by the turbocharger, the intermediate-compressor-process is performed by a screw type compressor, a rotary type compressor, or a scroll type intermediate-compressor, the final-compression-process is performed by the pistons of the combustion chambers; said intermediate-compressor is coupled to the compressor-transmission for adjusting the compression-capacity according to the instruction signals from the engine control unit, which computes the required compression-capacity by the user's power demand and the pressure in the cooling tank; said final-compression-process adjusts the actual-pressure-ratio with the actuation-time of the servo-intake-valve; said servo-intake-valve is opened for 5-60 degree of crankshaft rotation and is shut at a point between 90 degree BTC and 10 degree BTC according to instruction signals from the engine control unit; wherein the compressor-transmission is set to provide a higher airflow and said servo-intake-valve is shut at an earlier crankshaft reference angle to increase the actual-pressure-ratio of the final-compression-process for operating the direct-power-cycle at a high power output, whereas the compressor-transmission is set to provide a lower airflow and said servo-intake-valve is shut at a later crankshaft reference angle to decrease the actual-pressure-ratio of the final-compression-process for operating the direct-power-cycle at a lower power output.

### FIELD OF THE INVENTION

The present invention relates to an internal combustion engine operating on the basis of the direct-power-cycle, and more particularly to an improvement on the reduction of the compression loss and heat loss from internal combustion engine.

The present invention can be used in the field of transportation vehicle and power generation.

### BACKGROUND OF THE INVENTION

The present invention is an internal combustion engine operating with the direct-power-cycle for improving the fuel efficiency to above 30% and power-to-weight ratio of the engine system.

The fuel efficiency of the present invention is increased by performing a three-stage compression and a control airflow to the combustion chambers by both adjusting the compression-capacity of the intermediate-compressor and shifting the actuation-timing of the servo-intake-valve.

The three-stage compression of the present invention comprises the initial-compression-process, the intermediate-compression-process, and the final-compression-process.

The initial-compression-process is performed by a turbocharger system because the turbocharger system cannot provide a constant pressure boost to the ambient air, however, the turbocharger system is capable of recovering about 35% of the remained expansion energy in the exhaust gas through the turbine, thereby outputting a flow of low-boost air of about 1.5 bar to 5 bar from the compressor of the turbocharger system during the initial-compression-process.

The intermediate-compression-process is performed by an intermediate compressor of a screw type, a rotary type, a gear type, or scroll type, wherein the compression-capacity (compression speed) is adjusted by a transmission means, such that the intermediate-compressor takes in said flow of initial-boost air and outputs a flow of intermediate-boost air to the cooling-tank, since this intermediate-compression-process can adjust the compression-capacity in a boarder range, the air-pressure in the cooling-tank is maintained at a preset optimum pressure in any load condition (about 5 bar to 20 bar depending on the cooling-tank volume and the material strength); a built-in pressure sensor is included in the cooling-tank or the distributor-manifold to feedback the airflow data tot the engine control unit.

The cooling-tank lowers the temperature of the intermediate-boost air with the built-in cooling-circulation to prevent the knockings during the final-compression-process.

For the cost consideration, the gasoline or similar fuel can be supplied to mix with the intermediate-boost air in the distributor-manifold with a fuel injector or a carburetor, thereby forming an air-fuel mixture before entering the combustion chambers.

For the best performance with highest fuel efficiency, a GDI (gasoline direction injection) injector should be employed in each combustion chamber as the fuel supplying means (most of the disclosure of the present invention will be explained with the GDI injector).

The final-compression-process is performed in the combustion chamber, wherein the maximum compression pressure in the combustion chamber is about 200% to 400% of the air-pressure of the cooling-tank in heavy load operation, whereas the maximum compression pressure of the combustion will be about 150% to 200% of the air-pressure of the cooling-tank in medium load operation.

In comparison to the split-cycle engine or other two-stroke engines, the conventional engine has a high energy loss resulted from compression-stroke, the present invention provides a constant high power output with the minimum compression loss, and the power output is determined by the setting of the compressor-transmission and the servo-intake-valve, instead of the conventional throttle or variable valve timing system.

In comparison to the split cycle engine or other two-stroke compound engines, the present invention will have a much higher power-to-weight ratio and a lower manufacturing cost.

### SUMMARY OF THE INVENTION

It is the main objective of the present invention to provide a controlled-compression direct-power-cycle engine that can operate with a high fuel efficiency and light weight engine structure.

It is the second objective of the present invention to provide a controlled-compression direct-power-cycle engine that can control the engine power output by shifting the open-time and the shut-time of the servo-intake-valve to adjust the actual-pressure-ratio of the final-compression-process.

It is the third objective of the present invention to provide a controlled-compression direct-power-cycle engine that can minimize the energy loss of air-compression by multi-stage compression, wherein the initial-compression-process is performed with a compressor of the turbocharger system, the intermediate-compression-process is performed with an intermediate-compressor, and the final-compression-process is performed with the pistons of the combustion chambers.

It is the fourth objective of the present invention to provide a controlled-compression direct-power-cycle engine that adjusts the compression capacity of the intermediate-compressor with transmission means to maintain a preset optimum pressure in the cooling-tank, thereby compensating the unstable air-pressure of initial-boost air from the compressor of the turbocharger.

It is the fifth objective of the present invention to provide a highly efficient air-assistance system for storing the brake power as a compressed air in the cooling-tank with the intermediate-compressor during the braking process.

### BRIEF DESCRIPTION OF THE DRAWINGS

FIG. 1 is the illustrative view of the first embodiment, a controlled-compression direct-power-cycle engine.

FIG. 1A demonstrates an alternative form of the direct-power-cycle engine, wherein an exhaust-port is disposed on the associated chamber wall as exhaust means, each servo-intake-valve is disposed as an overhead valve in the engine head.

FIG. 1B is the illustrative view of the third embodiment, wherein the compression capacity of the intermediate compressor is adjusted by an electric motor transmission.

FIG. 2 is a process chart for demonstrating the possible process durations of the direct-power-cycle.

FIG. 2A is a process chart for demonstrating the process durations of the servo-intake-process, the final-compression-process, the combustion, the turbine-exhaust-process in lower power output operation.

FIG. 2B is a process chart for demonstrating the process durations of the servo-intake-process, the final-compression-process, the combustion, the turbine-exhaust-process in medium power output operation.

FIG. 2C is a process chart for demonstrating the process durations of the servo-intake-process, the final-compression-process, the combustion, the turbine-exhaust-process in high power output operation.

### DETAILED DESCRIPTION OF THE PREFERRED EMBODIMENTS

The pistons in the combustion chambers of the direct-power-cycle will perform a down-stroke and an up-stroke, wherein the TDC of the piston (top dead centre) is referred as 0 degree or 360 degree of the crankshaft reference angle, the BDC of the piston (bottom dead centre) is referred as 180 degree of crankshaft reference angle.

The direct-power-cycle consists of the initial-compression-process, the intermediate-compression-process, the cooling-process, the servo-intake-process, the final-compression-process, the combustion-process, and the turbine-exhaust-process; wherein the servo-intake-process, the final-compression-process, the combustion-process and the turbine-exhaust-process are performed in the combustion-chambers of the direct-power-cycle engine.

The ratio of the maximum compression pressure of the combustion chamber to the air-pressure of the cooling-tank is referred as the actual-pressure-ratio of the final-compression-process, wherein this actual-pressure-ratio is controlled by shifting both the actuation-timing and the shut-timing of the servo-intake-valve.

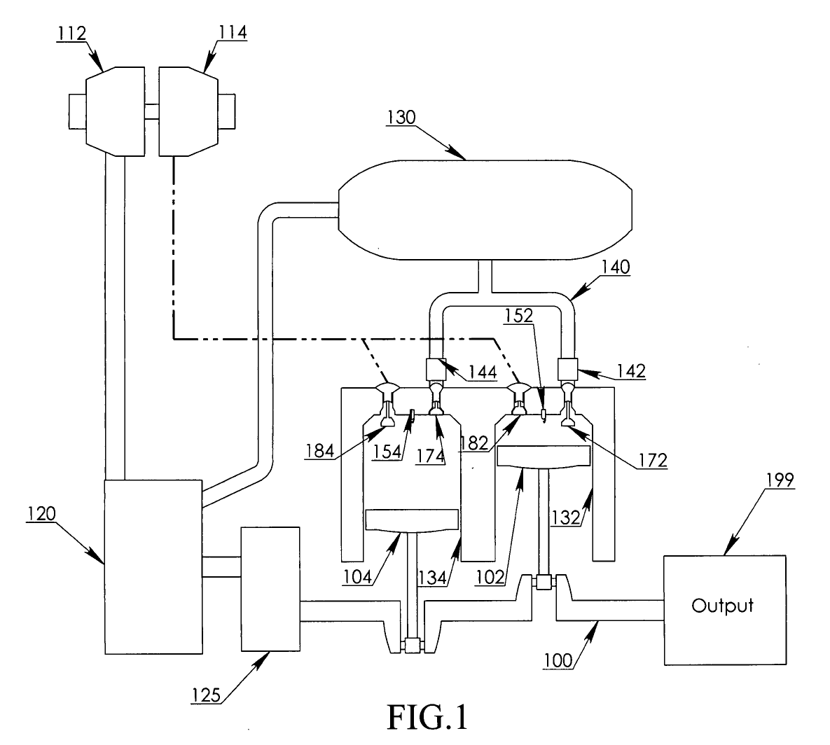

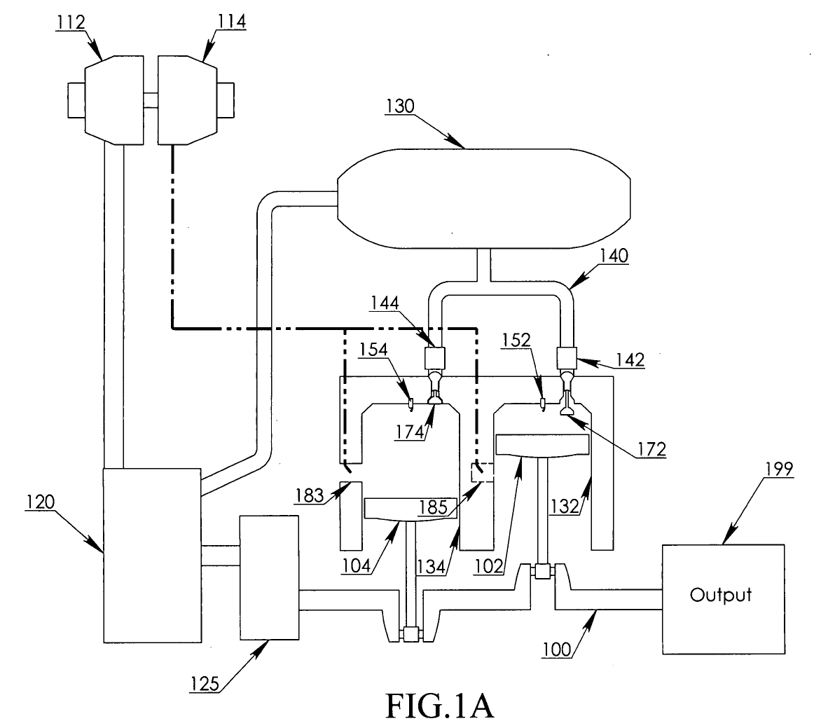

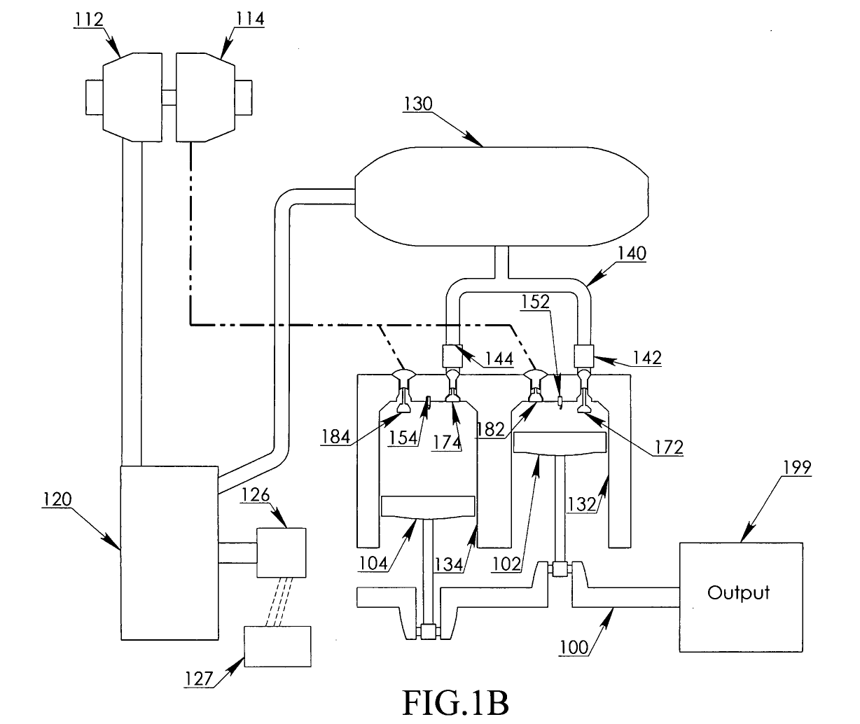

As shown in FIG. 1 is the illustrative view of the first embodiment, the components are labeled as the compressor 112 of the turbocharger, the turbine 114 of the turbocharger, the intermediate-compressor 120, the cooling-tank 130, the first combustion-chamber 132, the second combustion-chamber 134, the first servo-intake-valve 142, the second servo-intake-valve 144, the first exhaust-valve 182, the second exhaust-valve 184, the first spark-plug 152, the second spark-plug 154, the first fuel-injector 142, the second fuel-injector 144, the output section 199, the crankshaft 100, the compressor-transmission (or transmission means) 125 of the intermediate-compressor, the first piston 102, the second piston 104.

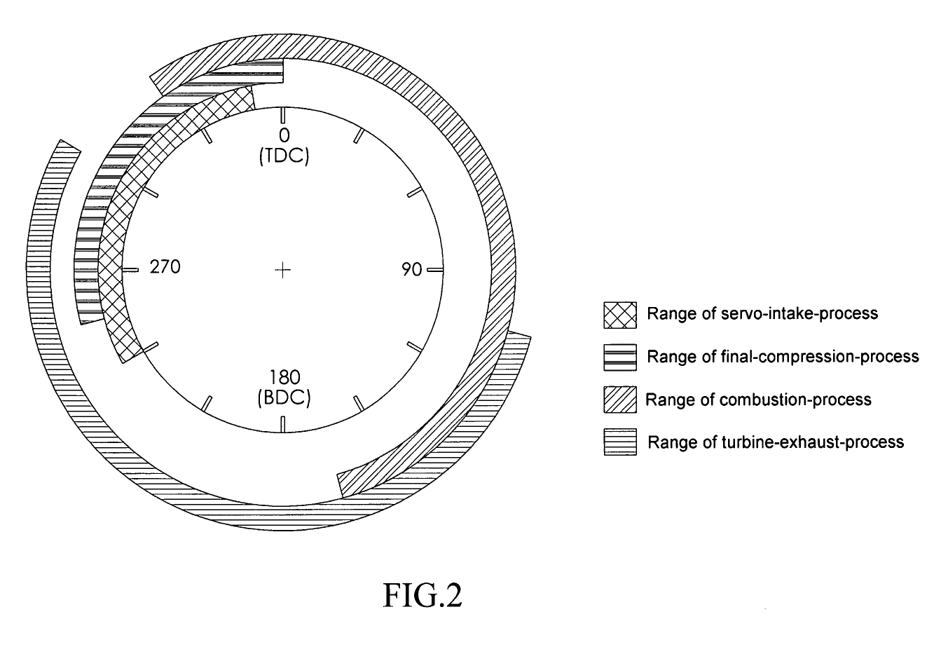

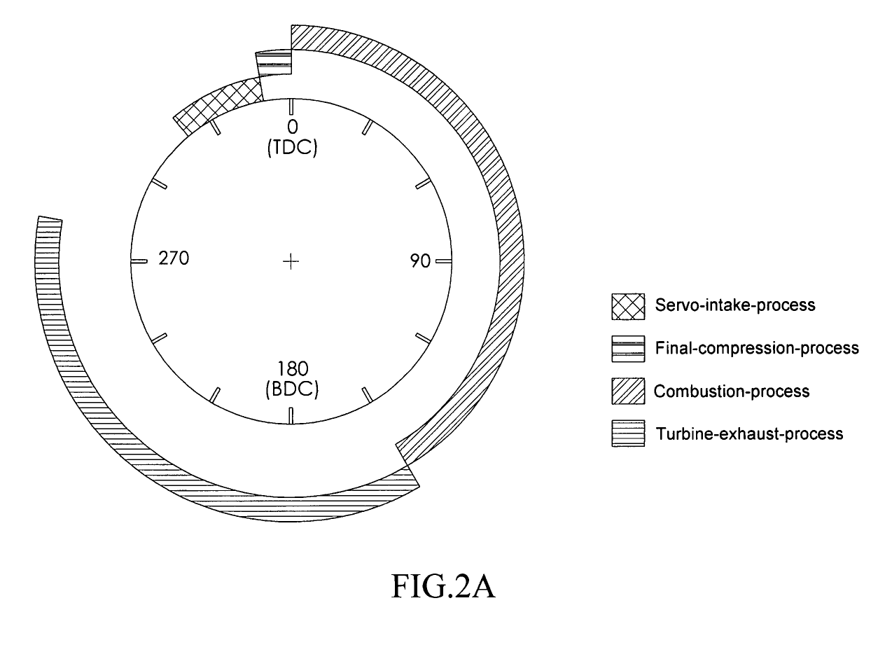

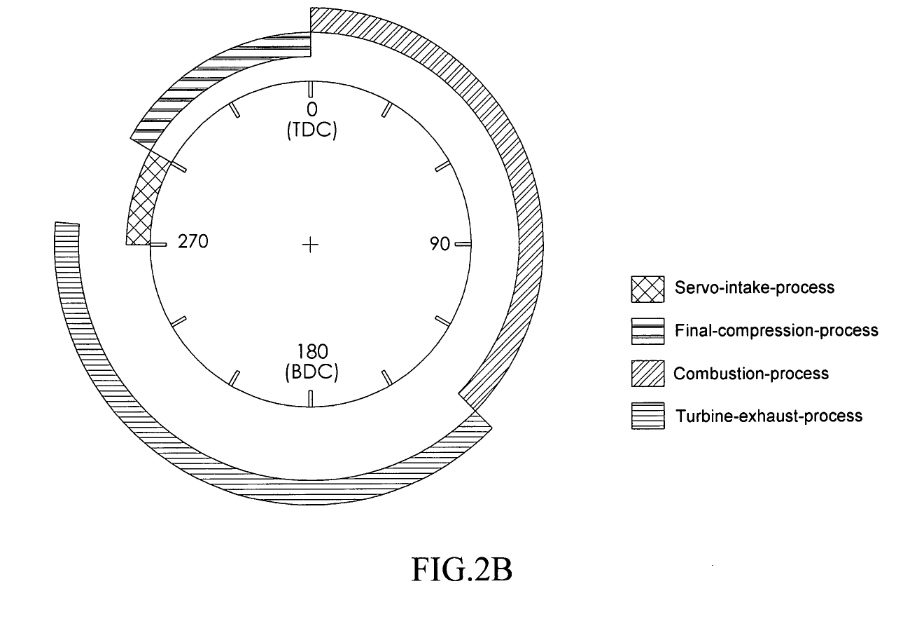

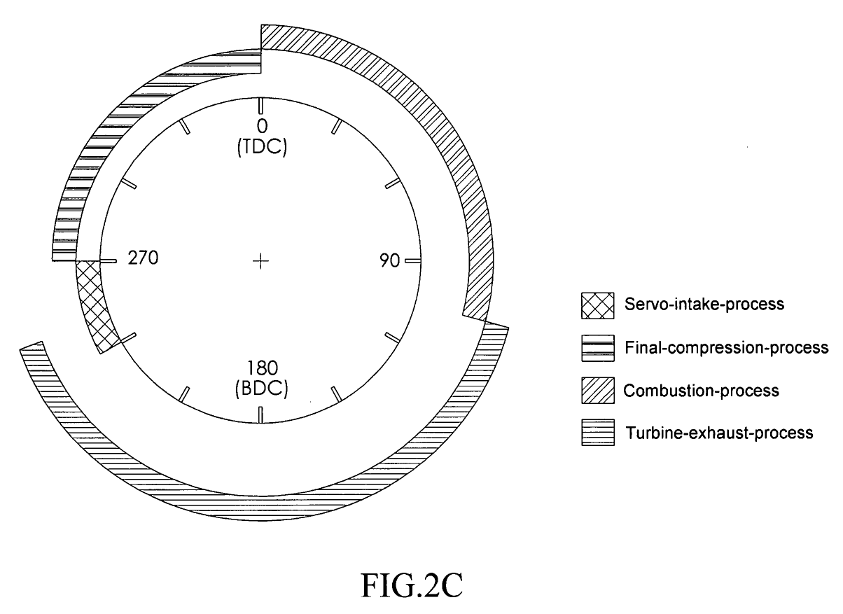

The servo-intake-process, the final-compression-process, the combustion-process and the turbine-exhaust-process is performed in the combustion-chamber, wherein a circular process chart in FIG. 2 shows the possible range of said four processes, wherein the servo-intake-process can be partially overlapping with the turbine-exhaust-process in high power output operation and medium power output operation to improve the exhaling of the exhaust gas, the final-compression-process is started after the completion of the servo-intake-process, the combustion-process is started after the completion of the final-compression-process, the turbine-exhaust-process is started after the completion of the combustion-process.

The initial-compression-process is the first process of the direct-power-cycle, which is to compress the ambient air with the compressor 122 of the turbocharger system, thereby providing a flow of initial-boost air at about 1.5 bar to 5 bar into the intermediate-compressor 120.

The intermediate-compression-process is the second process of the direct-power cycle, which is to compress said flow of initial-boost air with an adjustable compression capacity to supply a controlled flow of intermediate-boost air to the cooling-tank 130, wherein said adjustable compression capacity is controlled with the compressor-transmission 125.

The engine control unit will detect the air-pressure in the cooling-tank 130 with a pressure sensor; if the detected air-pressure is lower than a preset value in the ECU, the gear ratio of the compressor-transmission 125 will be shifted to a higher gear ratio to raise the compress capacity of the intermediate-compressor 120, thereby maintaining a preset optimum pressure in the cooling-tank 130; if the detected air-pressure is higher than a preset value in the ECU, the gear ratio of the compressor-transmission 125 will be shifted to a lower ratio to reduce the compression capacity of the intermediate-compressor 120, or the compressor-transmission 125 may disengage with a clutch for disconnecting the coupling gear from the crankshaft of the combustion chamber to temporally stop the operation of the intermediate-compressor 120, thereby maintaining a preset optimum pressure in the cooling-tank 130.

The main purpose of the compressor-transmission 125 is to provide an adjustable compression capacity of the intermediate-compressor 120, which will compensate for the unstable pressure boost from the compressor 112 of the turbocharger (the operational range of the turbocharger is relatively limited in comparison to the intermediate-compressor 120).

The air-pressure of the cooling-tank 130 is maintained at a pressure between 5 bar and 20 bar depending on the tank volume and material strength of the cooling-tank; in this embodiment, the air-pressure of the cooling-tank can be assumed at a constant pressure of about 10 bar in medium power output operation and high power output operation.

The cooling-process is the third process of the direct-power-cycle, which is the process to cool down the intermediate-boost air in the cooling-tank 130, wherein the cooling-tank 130 consists of cooling-circulation pipelines or cooling-fins (air-cooling); the cooling-tank may include a refrigerant type cooling-circulation-pipelines to achieve the best control of the temperature of the intermediate-boost air (this is most preferable for use in the heavy duty engine applications); the temperature of the intermediate-boost air should be between 40 degree Celsius and 120 degree Celsius.

The servo-intake-process is the fourth process of the direct-power-cycle, which is the process to inject a flow of intermediate-boost air from the cooling-tank 130 into the first combustion chamber 132 and the second combustion chamber 134 at their designated crankshaft reference angle; as shown in FIG. 2 the possible range of the servo-intake-process is from 240 degree to 350 degree of crankshaft reference angle.

The process chart of high power output operation as shown in FIG. 2C, the open-timing of the servo-intake-valve is set to 240 degree of crankshaft reference angle, the shut-timing is set to 270 degree of crankshaft reference angle, the total duration of the actuation of the servo-intake-valve is therefore 30 degree of crankshaft; the process chart of low power output operation as shown in FIG. 2A, the open-timing is set to 320 degree of crankshaft reference angle, the shut-timing is set to 350 degree of crankshaft reference angle; it can be seen that the valve actuation is shifted according to the engine power output.

The total duration of actuation of the servo-intake-valve is adjusted in the range of 5-60 degree of crankshaft rotation according to the instruction signals from the engine control unit, and the possible range of the servo-intake-process is from 240 degree to 350 degree of crankshaft reference angle.

The final-compression-process is the fifth process of the direct-power-cycle, which is the process to compress the intermediate-boost air in the combustion chambers 132 and 134, wherein the maximum compression pressure during this process will vary according to the engine power output; as in the process chart of low power output operation (FIG. 2A), the final-compression-process is from 350 degree to 360 degree of crankshaft reference angle, the air-pressure at the end of the final-compression-process is still about 10 bar; as shown in the process chart of medium power output operation (FIG. 2B), the final-compression-process is from 300 degree to 360 degree of crankshaft reference angle, and the air pressure at the end of the final-compression-process is increased to about 15 bar; as shown in the process chart of high power output operation (FIG. 2C), the final compression-process is from 270 degree to 360 degree of crankshaft reference angle, and the compression pressure at the end of the final-compression-process is increased to about 20 bar (the values of the compression pressure is only estimated for demonstration purpose, which are not elements or the limitations of the present invention); in general, the final-compression-process will increase the compression pressure to about 150%-200% of the air-pressure in the cooling-tank in medium power output operation, whereas the final-compression-process will increase the compression pressure to about 200%-400% of the air-pressure in the cooling-tank in high power output operation.

The ratio of the compression pressure at the end of the final-compression-process to the air-pressure in the cooling-tank is also referred as the actual-pressure-ratio of the final-compression-process for the ease of referencing. As shown in FIG. 2, the possible range of the final-compression-process is from 255 degree to 360 degree of crankshaft reference angle; the actual-pressure-ratio can vary from 70% to 400% depending on the engine power output (whereas, an actual-pressure-ratio slightly below 100% is possible in no load or extremely low load condition by shortening the servo-intake-process).

The fuel can be supplied with two different methods; the first method is to install a low pressure fuel injector or a carburetor in the distributor-manifold, which can reduce the overall cost of the engine; the second method is to install a GDI injector (gasoline direction injection injector) in each combustion chamber. In addition, the natural gas or propane can also be easily adapted to the present invention with a propane converter to substitute the abovementioned carburetor in the distributor-manifold, whereas, the GDI injector is also possible to inject natural gas.

The fuel is supplied into the combustion chamber during the servo-intake-process or the final-compression-process with the abovementioned fuel-supplying means, and a spark plug will ignite the air-fuel mixture between 35 degree BTDC (before top dead centre) and 40 degree ATDC (after top dead centre) to initiate the combustion-process; the first embodiment will employ an ignition timing at 360 degree (0 degree) of crankshaft reference angle for the demonstration purpose in all the process charts of FIG. 2A-C.

The combustion-process is the sixth process of the direct-power-cycle, wherein an air-fuel mixture is combusting in the combustion chambers 132 and 134 after the completion of the final-compression-process; as shown in FIG. 2, the possible range of the combustion-process is from 325 degree to 165 degree of crankshaft reference angle, in other words, this range is between 35 degree BTDC and 165 degree ATDC; the end of the combustion process is determined by the actuation-timing of the exhaust-valve or the beginning of the turbine-exhaust-process; the combustion process is from 0 degree to 105 degree in FIG. 2C, the combustion process is from 0 degree to 135 degree in FIG. 2B, the combustion process is from 0 degree to 150 degree in FIG. 2A.

The turbine-exhaust-process is the seventh process of the direct-power-cycle, wherein the combustion medium of the combustion chamber is charging into the turbine of the turbocharger in order to drive the compressor of the turbocharger for commencing the initial-compression-process; the exhaust-valve can also be actuated with a variable open-time scheme according to the engine power output, thereby preventing excessive combustion medium to remain in the combustion chamber prior to the next servo-intake-process; as shown in FIG. 2, the possible range of the turbine-exhaust-process is from 105 degree to 300 degree of crankshaft reference angle, wherein the overlapping between the turbine-exhaust-process and the servo-intake-process should be less than 30 degree of crankshaft rotation; as shown in the process chart of high power output operation (FIG. 2C), the turbine-exhaust-process is from 105 degree to 250 degree, wherein the 10 degree overlapping between the turbine-exhaust-process and the servo-intake-process will enhance the exhaling of the combustion-medium for better the engine performance; as shown in the process chart of medium power output operation (FIG. 2B), the turbine-exhaust-process is from 135 degree to 275 degree of crankshaft reference angle, the overlapping is 5 degree of crankshaft rotation, which leaves partial combustion-medium in the associated combustion chamber, creating an effect similar to the EGR (exhaust gas recirculation) of the four-stroke engine; as shown in the process chart of low power output operation (FIG. 2A), the turbine-exhaust-process is from 150 degree to 280 degree of crankshaft reference angle, as there is no overlapping between the turbine-exhaust-process and the servo-intake-process, a higher percentage of the combustion-medium is remained in the combustion chamber to mix with the intermediate-boost air of the next servo-intake-process, this effect (similar to EGR) is optional if the fuel supplying means is a carburetor or a low pressure fuel injector, whereas this effect is generally required for GDI injector type direct-power-cycle engine.

The possible range of the turbine-exhaust-process is from 105 degree to 300 degree of crankshaft reference angle, and the duration of actuation of the exhaust valve should be at least 90 degree of crankshaft rotation.

The cooling-tank 130 can be employed with an air-cooling system or a refrigerant-cooling system; when used in a vehicle applications, the refrigeration circulation of the air-conditioning can be integrated with the cooling-circulation of the cooling-tank to reduce the overall vehicle size.

The direct-power-cycle engine may further include an air-assistance system, wherein the major modification is the actuation system of the servo-intake-valve and the exhaust-valve, such that, during a brake process, the servo-intake-valve and the exhaust-valve are disabled, the compressor-transmission of the intermediate-compressor will be set to high gear ratio, thereby increasing the revolution speed and the compression-capacity of the intermediate-compressor to recover the brake energy as a compressed air in the cooling tank.

A catalytic converter can be equipped in the exhaust gas passage between the combustion chamber and the turbine of the turbocharger, so that the thermo energy released in the catalytic converter can be recovered with the turbocharger.

Referring to FIG. 1A is another alternative form of the direct-power-cycle engine, wherein the exhaust-ports 183 and 185 are disposed on the lower middle section of the chamber walls, the servo-intake-valve 144 and 142 are disposed as an overhead valve in the engine head; the exhaust-ports 183 and 185 are rather similar to that of the traditional two-stroke engine, wherein the combustion medium will be expelled out of the combustion chamber as long as the piston is reciprocating below the position of the exhaust-port, regardless of the low manufacturing cost, the servo-intake-valve of this configuration will require to inject a flow of the intermediate-boost air at a relative earlier crankshaft reference angle in order to blow out the combustion-medium through the exhaust-port, the servo-intake-process of this configuration may start from as early as 180 degree of crankshaft reference angle.

Referring to FIG. 1B for another alternative form of the direct-power-cycle engine, wherein the direct-power-cycle engine uses an inverter system 127 and an electrical motor transmission 126 for the intermediate-compressor; most basic components operate with the same function as in the first embodiment, except that the intermediate-compressor is driven by an electrical motor, the revolution of the electrical motor is controlled by the inverter system, while the inverter system 127 receives the instruction signal to adjust the revolution speed of the intermediate-compressor 120 at a more accurate scale; said inverter system 127 will harvest the mechanical energy from the output shaft or the crankshaft of the combustion chambers as electricity, and this electricity is used to driven the electrical motor at a controlled revolution speed.

The actuation-system of the servo-intake-valve of the direct-power-cycle engine can be a hydraulic actuation system, a mechanical variable-valve-timing system, or an electrical servo-valve system.

The intermediate-compressor of the direct-power-cycle engine can a screw type compressor, a scroll type compressor, a rotary-vane type compressor, or a piston type compressor; wherein the scroll type compressor, the rotary type compressor, and the screw type compressor are the most preferable for the highly efficient compression output and the low vibration characteristics.

The fuel supplying means of the direct-power-cycle engine can a carburetor, a direction injection nozzle, a GDI injector, a fuel-pump, or a propane converter; wherein the fuel can gasoline, methanol, natural gas, bio-fuel, propane, or a mixture of abovementioned fuel types that can be ignited with the spark ignition method.

The cooling-tank of the direct-power-cycle engine can operate with a refrigerant-circulation system, an air-circulation system, or a water-circulation system to perform the cooling-process of the direct-power-cycle.

The physical compression ratio of the combustion chamber of the direct-power-cycle engine ranges from 8:1 to 40:1, whereas the actual-pressure-ratio of the final-compression-process refers to the ratio of the compression pressure at the end of the final-compression-process to the air-pressure in the cooling-tank; the actual-pressure-ratio can range from 70% to 400%, for example with a direct-power-cycle engine operating with a constant pressure of 10 bar in the cooling-tank, the compression pressure at the end of the final-compression-process is then ranged from 7 bar to 28 bar according to the requested power output, wherein a higher actual-pressure-ratio of the final-compression-process will result in a higher power output of the direct-power-cycle engine.

The air passage between the compressor of the turbine (for performing the initial-compression-process) and the intermediate-compressor can further include an additional intercooler for cooling the initial-boost air from the compressor of the turbocharger in heavy duty engine applications or power generation applications.

The transmission means (compressor-transmission) of the intermediate-compressor is a continuously variable transmission, a mechanical gear transmission, or a hydraulic transmission.

It should be understood that there are more than one best mode in the present invention, as the direct-power-cycle engine can be constructed in many further developed forms by combining or rearranging the basic engine components mentioned in the present invention, and these alternations are still within the scope of the present invention.

1. A controlled-compression direct-power-cycle engine comprising:
a) at least two combustion chambers, an engine control unit, and a crankshaft; wherein each combustion chamber includes a reciprocating piston, a servo-intake-valve, an exhaust-valve, and ignition means;
b) a fuel-supplying means;
c) a turbocharger system;
d) an intermediate-compressor and a compressor-transmission; wherein said intermediate-compressor is driven by said compressor-transmission, and said compressor-transmission shifts the associated gear setting by instruction signals from the engine control unit;
e) a cooling-tank and a pressure-sensor; wherein, said pressure-sensor feedbacks the air pressure data of the cooling-tank to the engine control unit;
f) an servo-actuation system for actuating said servo-intake-valve and exhaust-valve of each combustion chamber according to instruction signals from the engine control unit; and
g) the controlled compression direct-power-cycle engine operates the seven processes, said seven process are the initial-compression-process, the intermediate-compression-process, the cooling-process, the servo-intake-process, the final-compression-process, the combustion-process, and the turbine-exhaust-process; wherein:
the initial-compression-process is performed with a compressor of said turbocharger system to output a flow of initial-boost air into said intermediate-compressor;
the intermediate-compression-process is performed with said intermediate-compressor to output a flow of intermediate-boost air to said cooling-tank, said flow of intermediate-boost air is at an air-pressure between 5 bar and 20 bar; said compressor-transmission is instructed by the engine control unit to adjust the compression-capacity and the airflow of said intermediate-compressor to maintain a stable air-pressure in the cooling-tank;
the cooling-process is performed in said cooling-tank, the intermediate-boost air is cooled in said cooling-tank with a cooling-circulation system;
the servo-intake-process is performed with the servo-actuation system; wherein a flow of intermediate-boost air is distributed from said cooling-tank into each combustion chamber with the associated servo-intake-valve at a controlled actuation-timing instructed by the engine control unit, the engine control unit adjusts the shut-timing of said servo-intake-valves to regulated the amount of the air taken during the servo-intake-process, thereby preventing engine knocking and controlling the engine power output; the possible range of the servo-intake-process is from 240 degree to 350 degree of crankshaft reference angle;
the final-compression-process is performed in each combustion chamber with the associated piston after the associated servo-intake-valve is shut, wherein the compression pressure at the end of the final-compression-process can range from 70% to 400% of the air-pressure in said cooling-tank, the possible range of the final-compression-process is from 255 degree to 360 degree of crankshaft reference angle;
the combustion-process is performed in each combustion chamber with the associated ignition means; wherein the possible range of the combustion-process is from 35 degree BTDC to 165 degree ATDC;
the turbine-exhaust-process is performed with a turbine of said turbocharger system, wherein a flow of combustion medium from each combustion chamber is distributed to said turbine of the turbocharger system via the associated exhaust valve; the possible range of the turbine-exhaust-process is from 105 degree to 300 degree of crankshaft reference angle.

2. A controlled-compression direct-power-cycle engine as defined in claim 1, wherein; the compressor-transmission may be disengaged with a clutch or reduce the compression-capacity after an adequate amount of compressed-air is stored in said cooling-tank.

3. A controlled-compression direct-power-cycle engine as defined in claim 2, wherein; the servo-actuation-system is a hydraulic actuation system, a mechanical variable-valve-timing system, or an electrical servo-valve system.

4. A controlled-compression direct-power-cycle engine as defined in claim 3, wherein; said cooling-tank includes a refrigerant type cooling-circulation system or an air-cooling type cooling-circulation for reducing the temperature of the intermediate-boost-air in said cooling-tank.

5. A direct-power-cycle engine with air-assistance system as defined in claim 4, wherein; said intermediate-compressor is a screw type compressor, a scroll type compressor, a gear type compressor, a piston type compressor or a rotary-vane type compressor; said compressor-transmission is a mechanical gear transmission, a continuously-variable-transmission, or a hydraulic transmission.

6. A controlled-compression direct-power-cycle engine with electric motor transmission system comprising:
a) at least two combustion chambers, an engine control unit, and a crankshaft; wherein each combustion chamber includes a reciprocating piston, a servo-intake-valve, an exhaust-valve, and ignition means;
b) a fuel-supplying means;
c) a turbocharger system;
d) an intermediate-compressor and an electric motor transmission system; wherein said intermediate-compressor is driven by an electric motor of said electric motor transmission system, said electric motor transmission system harvest mechanical power from the crankshaft with a generator or an alternator to a controlled amount electricity for driving the electric motor at a speed instructed by the engine control unit;
e) a cooling-tank and a pressure-sensor; wherein, said pressure-sensor feedbacks the air pressure data of the cooling-tank to the engine control unit;
f) an servo-actuation system for actuating said servo-intake-valve and exhaust-valve of each combustion chamber according to instruction signals from the engine control unit; and
g) the controlled compression direct-power-cycle engine operates the seven processes, said seven process are the initial-compression-process, the intermediate-compression-process, the cooling-process, the servo-intake-process, the final-compression-process, the combustion-process, and the turbine-exhaust-process; wherein:
the initial-compression-process is performed with a compressor of said turbocharger system to output a flow of initial-boost air into said intermediate-compressor;
the intermediate-compression-process is performed with said intermediate-compressor to output a flow of intermediate-boost air to said cooling-tank, said flow of intermediate-boost air is at an air-pressure between 5 bar and 20 bar; said electric motor transmission system is instructed by the engine control unit to adjust the compression-capacity and the airflow of said intermediate-compressor to maintain a stable air-pressure in the cooling-tank;
the cooling-process is performed in said cooling-tank, the intermediate-boost air is cooled in said cooling-tank with a cooling-circulation system;
the servo-intake-process is performed with the servo-actuation system; wherein a flow of intermediate-boost air is distributed from said cooling-tank into each combustion chamber with the associated servo-intake-valve at a controlled actuation-timing instructed by the engine control unit, the engine control unit adjusts the shut-timing of said servo-intake-valves to regulated the amount of the air taken during the servo-intake-process, thereby preventing engine knocking and controlling the engine power output; the possible range of the servo-intake-process is from 240 degree to 350 degree of crankshaft reference angle;
the final-compression-process is performed in each combustion chamber with the associated piston after the associated servo-intake-valve is shut, wherein the compression pressure at the end of the final-compression-process can range from 70% to 400% of the air-pressure in said cooling-tank, the possible range of the final-compression-process is from 255 degree to 360 degree of crankshaft reference angle;
the combustion-process is performed in each combustion chamber with the associated ignition means; wherein the possible range of the combustion-process is from 35 degree BTDC to 165 degree ATDC;
the turbine-exhaust-process is performed with a turbine of said turbocharger system, wherein a flow of combustion medium from each combustion chamber is distributed to said turbine of the turbocharger system via the associated exhaust valve; the possible range of the turbine-exhaust-process is from 105 degree to 300 degree of crankshaft reference angle;

7. A controlled-compression direct-power-cycle engine as defined in claim 6, wherein; the compressor-transmission may be disengaged with a clutch or reduce the compression-capacity after an adequate amount of compressed-air is stored in said cooling-tank.

8. A controlled-compression direct-power-cycle engine as defined in claim 7, wherein; the servo-actuation-system is a hydraulic actuation system, a mechanical variable-valve-timing system, or an electrical servo-valve system.

9. A controlled-compression direct-power-cycle engine as defined in claim 8, wherein; said cooling-tank includes a refrigerant type cooling-circulation system or an air-cooling type cooling-circulation for reducing the temperature of the intermediate-boost-air in said cooling-tank.

10. A direct-power-cycle engine with air-assistance system as defined in claim 9, wherein; said intermediate-compressor is a screw type compressor, a scroll type compressor, a gear type compressor, a piston type compressor or a rotary-vane type compressor; said compressor-transmission is a mechanical gear transmission, a continuously-variable-transmission, or a hydraulic transmission.

11. A controlled-compression direct-power-cycle engine comprising:
a) at least two combustion chambers, an engine control unit, and a crankshaft; wherein each combustion chamber includes a reciprocating piston, a servo-intake-valve, an exhaust means, and ignition means;
b) a fuel-supplying means;
c) an intermediate-compressor and a compressor-transmission means; wherein the engine control unit instructs the transmission means to drive the intermediate-compressor for controlling the engine power output of the controlled-compression direct-power cycle engine;
d) a cooling-tank and a pressure-sensor; wherein, said pressure-sensor feedbacks the air pressure data of the cooling-tank to the engine control unit;
e) an servo-actuation system for actuating said servo-intake-valve of each combustion chamber according to instruction signals from the engine control unit; and
f) the controlled compression direct-power-cycle engine operates a direct-power-cycle consisting of an intermediate-compression-process, a cooling-process, a servo-intake-process, a final-compression-process, a combustion-process, and a turbine-exhaust-process; wherein:
the intermediate-compression-process is performed with said intermediate-compressor to output a flow of intermediate-boost air to said cooling-tank, said flow of intermediate-boost air is at an air-pressure between 5 bar and 20 bar; said compressor-transmission means is instructed by the engine control unit to adjust the compression-capacity and the airflow of said intermediate-compressor to maintain a stable air-pressure in the cooling-tank;
the cooling-process is performed in said cooling-tank, the intermediate-boost air is cooled in said cooling-tank with a cooling-circulation system;
the servo-intake-process is performed with the servo-actuation system; wherein a flow of intermediate-boost air is distributed from said cooling-tank into each combustion chamber with the associated servo-intake-valve at a controlled actuation-timing instructed by the engine control unit, the engine control unit adjusts the shut-timing of said servo-intake-valves to regulated the amount of the air taken during the servo-intake-process, thereby preventing engine knocking and controlling the engine power output;
the final-compression-process is performed in each combustion chamber with the associated piston after the associated servo-intake-valve is shut, wherein the compression pressure at the end of the final-compression-process can range from 70% to 400% of the air-pressure in said cooling-tank;
the combustion-process is performed in each combustion chamber with the associated ignition means;
the turbine-exhaust-process is performed with a turbine of said turbocharger system, wherein a flow of combustion medium from each combustion chamber is distributed to said turbine of the turbocharger system via the associated exhaust means.

12. A controlled-compression direct-power-cycle engine as defined in claim 11, wherein; said exhaust means of each combustion chambers is an exhaust port on chamber wall.

13. A controlled-compression direct-power-cycle engine as defined in claim 11, wherein; said exhaust means of each combustion chambers is an exhaust valve driven by said servo-actuation system.

14. A controlled-compression direct-power-cycle engine as defined in claim 11, wherein; the servo-actuation-system is a hydraulic actuation system, a mechanical variable-valve-timing system, or an electrical servo-valve system.
